(19) United States
(12) Patent Application Publication
(10) Pub. No.: US 2007/0229014 A1
(43) Pub. Date: Oct. 4, 2007

(54) Method for operating a control system of an industrial process

(75) Inventor: Ralf Huck, Grosskrotzenburg (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/717,700

(22) Filed: Mar. 14, 2007

(30) Foreign Application Priority Data
Mar. 14, 2006 (DE) 10 2006 011 500.7

(51) Int. Cl. G05B 19/10

(52) U.S. Cl. 318/567

(57) ABSTRACT

The invention relates to a method for operating a control system of an industrial process, the control system having at least one control loop comprising a sensor (200), a control device (300) and an actuator (400), the actuator being connected to the sensor (200) via the industrial process (100). To detect faults in the control loop, it is proposed to inject (51, 52) a predefined test signal at an arbitrary point of the control loop, and to monitor (61 to 63) the response of the control loop as a function of the test signal at a separation of at least one control-loop element.

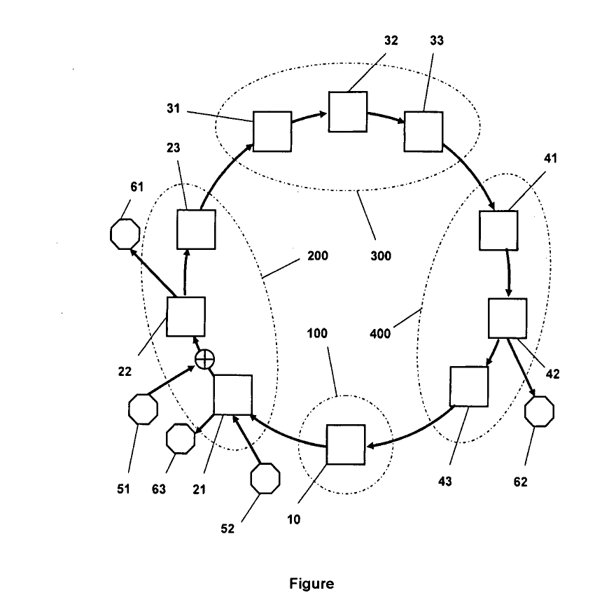

The invention relates to a method for operating a control system of an industrial process, the control system having at least one control loop comprising a plurality of control-loop elements, but comprising at least one sensor, one control device and one actuator, the actuator being connected to the sensor via the industrial process.

A control loop normally has a sensor that is connected to an input of a control device. The control device is equipped with at least one output, to which an actuator is connected. An industrial process, whose parameters are set by the actuator and detected by the sensor, closes the control loop. The control device outputs to the actuator a control value that depends on the measured value detected by the sensor. The measured values can be transmitted from the sensor to the control device, and from the control device to the actuator, in analog or digital form by wired or wireless communication.

Interruptions in transmission occur as a result of faults, and the interruptions remain undetected.

Thus the object of the invention is to define a method for operating a control system of an industrial process that enables detection of faults in the control loop.

This object is achieved according to the invention by the means of claim 1. Advantageous embodiments of the invention are given in the dependent claims.

The invention is based on a control system of an industrial process, the control system having at least one control loop comprising a plurality of control-loop elements. The control-loop elements include at least one sensor, one control device and one actuator, which are connected together in that order into a control loop via the industrial process. Each of the control-loop elements cited can also be composed internally of further control-loop elements.

According to the invention, a predefined test signal is injected at an arbitrary point of the control loop. The response of the control loop as a function of the test signal is monitored at another point of the control loop that is separated by at least one control-loop element from the injection point.

The test signal here passes through all the control-loop elements and the connecting elements between the control-loop elements of the whole control loop. Faults in the control loop have an effect on the test signal and its transmission within the control loop. The nature of the fault can be deduced from the form that the effect takes.

Even faults such as broken connecting wires, frozen measured values and/or control values, damaged sensors and/or actuators, incorrectly connected control-loop elements or combinations of such faults are advantageously detected by this means. Control loops having a slow dynamic response benefit in particular from this advantage.

The characterizing parameters of the test signal, which are essentially defined by the duration, polarity and signal shape, can be defined. The test signal advantageously does not contain common-mode components and is of short duration in order to avoid interfering with the industrial process.

According to another feature of the invention, the test signal is coupled in at the sensor of a control loop. The test signal here passes through the control loop as an electrical signal as far as the actuator, before passing into the industrial process as a physical signal. The response of the control loop to the test signal is advantageously available as an electrical signal at any control-loop elements outside the industrial process.

According to a further feature of the invention, an expected value of the change in measured signal is assigned to the test signal. The superimposed signal is sent to the control device. After a definable time has elapsed, the change in measured signal that is actually detected is compared with the expected value of the change in measured signal. The differences found between the change in measured signal actually detected and the expected value of the change in measured signal are signaled as an alert to a higher-level device.

According to a further feature of the invention, the test signal is superimposed periodically on the measured signal. This advantageously achieves continuous fault detection for minimum impact on the industrial process.

According to a further feature of the invention, the test signal is superimposed on the measured signal on the basis of a given event occurring. This feature permits automatic initiation of a test on the basis of detecting an incorrect response of the control loop.

The invention is described in greater detail below with reference to an exemplary embodiment and the necessary drawings, in which:

the single FIGURE shows a block diagram of a control loop having a plurality of control-loop elements 10 to 43, which are grouped into physical units and assigned to an industrial process. The control-loop elements 21 to 23 are parts of a sensor 200. The control-loop elements 31 to 33 form a control device 300, and the control-loop elements 41 to 43 constitute an actuator 400. The industrial process 100 is represented as a single control-loop element 10 regardless of its complexity.

A predefined test signal is injected at an arbitrary point of the control loop by conventional means. The response of the control loop as a function of the test signal is monitored at another point of the control loop that is separated by at least one control-loop element 10 to 43 from the injection point.

In a first embodiment of the invention, a test-signal source 51 is provided, whose test signal is superimposed on the control-loop signal between two consecutive control-loop elements 21 and 22 at a summation point in the sensor 200. In this case, an electrical test signal can be coupled in at the summation point by resistive, capacitive or inductive methods known per se.

The test signal is coupled out at another point of the control loop that is separated by at least one control-loop element 10 to 43 from the injection point. For the situation where the test signal is injected by the test signal-source 51, the nearest signal coupling-out point 61 is given at the output of the control-loop element 22. Alternatively, it can be provided that the test signal is coupled out at any other suitable point of the control loop, such as at the signal coupling-out point 62 at the output of the control-loop element 42, but at the latest at the signal coupling-out point 63 at the control-loop element 21.

In a second embodiment of the invention, a test-signal source 52 is provided, which injects a test signal directly into a control-loop element 21. It can be provided for this purpose that a test signal is superimposed on the measurement current of a sensor 200, which is normally kept at a constant level.

The response to the test signal of the control-loop elements 10 to 43 included between the coupling-in and coupling-out points is detected, depending on the position of the test-signal sources 51 and 52 and the signal coupling-out points 61 to 63. The test signal here passes through all the control-loop elements 10 to 43 and the connecting elements between the control-loop elements 10 to 43 of the whole control loop. Faults in the control loop have an effect on the test signal and its transmission within the control loop. The nature of the fault can be deduced from the form that the effect takes.

In a further embodiment of the invention, an expected value of the change in measured signal is assigned to the test signal. The superimposed signal is sent to the control device 300. After a definable time has elapsed, the change in measured signal that is actually detected is compared with the expected value of the change in measured signal. The differences found between the change in measured signal actually detected and the expected value of the change in measured signal are signaled as an alert to a higher-level device.

In a further embodiment of the invention, the test signal is superimposed periodically on the measured signal. This advantageously achieves continuous fault detection in the control system for minimum impact on the industrial process.

In a further embodiment of the invention, the test signal is superimposed on the measured signal on the basis of a given event occurring. This feature permits automatic initiation of a test on the basis of the detected incorrect response of the control loop. It can be provided in this case that the initial event is actuated manually as required. Alternatively, it can be provided that the test of the control loop is initiated by a definable time period elapsing without a change in measured signal.

### LIST OF REFERENCES

10 to 43 control-loop element
51, 52 test-signal source
61 to 63 signal coupling-out point
100 process
200 sensor
300 control device
400 actuator

1. A method for operating a control system of an industrial process, the control system having at least one control loop comprising a sensor, a control device and an actuator, the actuator being connected to the sensor via the industrial process,
wherein
a predefined test signal is injected at an arbitrary point (51, 52) of the control loop, and
the response of the control loop as a function of the test signal is monitored at a separation of at least one control-loop element (41 to 43).

2. The method as claimed in claim 1,
wherein
a test signal of defined duration, polarity and signal shape is temporarily superimposed on the measured signal detected by the sensor (200), with an expected value of the change in measured signal being assigned to each test signal,
the superimposed signal is sent to the control device (300)
after a definable time has elapsed, the change in measured signal that is actually detected is compared with the expected value of the change in measured signal, and
differences between the change in measured signal actually detected and the expected value of the change in measured signal are signaled as an alert.

3. The method as claimed in claim 2,
wherein
the test signal is superimposed periodically on the measured signal.

4. The method as claimed in claim 2,
wherein
the test signal is superimposed on the measured signal on the basis of a given event occurring.
